(19) United States
(12) Patent Application Publication
(10) Pub. No.: US 2024/0019811 A1
(43) Pub. Date: Jan. 18, 2024

(54) AIR IONIZATION DISPLAY APPARATUS AND CONTROL METHOD THEREFOR

(71) Applicant: ANHUI EASPEED TECHNOLOGY CO., LTD., Hefei (CN)

(72) Inventors: Biao CHEN, Hefei (CN); Chengfei HAN, Hefei (CN); Liangliang ZHANG, Hefei (CN)

(21) Appl. No.: 18/476,297

(22) Filed: Sep. 27, 2023

Related U.S. Application Data
(63) Continuation of application No. PCT/CN2022/093932, filed on May 19, 2022.

(30) Foreign Application Priority Data
Jun. 22, 2021 (CN) 202110693799.7

(51) Int. Cl. G03H 1/26; G02B 27/10; H04N 13/365; H04N 13/346; G03H 1/00; G02B 13/00; H01S 3/00

(52) U.S. Cl. CPC G03H 1/26; G02B 27/108; H04N 13/365; H04N 13/346; G03H 1/0005; G02B 13/0005; H01S 3/0057; G03H 2001/0088

(57) ABSTRACT

Provided are an air ionization display apparatus and a control method therefor, which relate to the field of imaging technologies. The air ionization display apparatus includes: a pulse laser source configured to generate a pulse laser beam; a beam splitter configured to split the pulse laser beam into a first sub-beam and a second sub-beam; a pulse laser regulation assembly configured to regulate a wavelength of the second sub-beam to obtain a third sub-beam, and regulate a time difference between the third sub-beam and the first sub-beam to delay an emission of the third sub-beam; a beam combiner configured to combine the first sub-beam and the third sub-beam that is subject to the delayed emission to obtain a combined beam; and a light field adjustment and control assembly configured to adjust and converge the combined beam, and ionize air at a display region to form a holographic image.

### CROSS-REFERENCE TO RELATED APPLICATION

The present application is a continuation of International Application No. PCT/CN2022/093932 filed on May 19, 2022, which claims a priority to Chinese Patent Application No. 202110693799.7, entitled “AIR IONIZATION DISPLAY APPARATUS AND CONTROL METHOD THEREFOR”, and filed on Jun. 22, 2021, the entire content of which is incorporated herein by reference.

### FIELD

The present disclosure relates to the field of imaging technologies, and more

particularly, to an air ionization display apparatus and a control method therefor.

### BACKGROUND

In an imaging process of an air ionization imaging system, a lens needs to be used to converge a beam, and air is ionized at a focal point of the lens to form a light spot. Due to a high optical power threshold per unit area of a pulse required for forming air ionization, the number of focal points formed by a spatial light modulator modulating a light field at each ionization point is limited by pulse power. That is, the number of pixels of a display picture is limited by a magnitude of the pulse power. To increase the number of pixels of the display picture, pulse output power of a light source needs to be further raised. However, in the related art, it is difficult to greatly improve the pulse output power of the light source.

In addition, optical components such as a zoom lens in an air ionization display system have limited damage thresholds, which usually make it difficult for the optical components to withstand a pulse laser having a high peak power density for a long time, resulting in an upper limit of the pulse output power of the light source. Due to the above factors, a picture region displayed by the air ionization is small and cannot meet a demand for large-picture imaging display in the air.

### SUMMARY

The present disclosure aims to solve at least one of the technical problems in the related art to some extent. To this end, a first object of the present disclosure is to provide an air ionization display apparatus to realize a large range of air ionization at a relatively low output power of a laser source.

A second object of the present disclosure is to provide a control method for an air ionization display apparatus.

To achieve the above objects, in a first aspect, embodiments of the present disclosure provide an air ionization display apparatus. The apparatus includes: a pulse laser source configured to generate a pulse laser beam; a beam splitter configured to split the pulse laser beam into a first sub-beam and a second sub-beam; a pulse laser regulation assembly configured to regulate a wavelength of the second sub-beam to obtain a third sub-beam, and regulate a time difference between the third sub-beam and the first sub-beam to delay an emission of the third sub-beam; a beam combiner configured to combine the first sub-beam and the third sub-beam that is subject to the delayed emission to obtain a combined beam; and a light field adjustment and control assembly configured to adjust and converge the combined beam, and ionize air at a display region to form a holographic image.

To achieve the above objects, in a second aspect, the embodiments of the present disclosure provide a control method for an air ionization display apparatus. The method is applied in the air ionization display apparatus and includes: outputting, by the pulse laser source, the pulse laser beam, and splitting, by the beam splitter, the pulse laser beam into the first sub-beam and the second sub-beam; regulating, by the pulse laser regulation assembly, the wavelength of the second sub-beam to obtain the third sub-beam, and regulating, by the pulse laser regulation assembly, the time difference between the third sub-beam and the first sub-beam, to delay the emission of the third sub-beam; combining, by the beam combiner, the first sub-beam and the third sub-beam that is subject to the delayed emission to obtain the combined beam; adjusting and converging, by the light field adjustment and control assembly, the combined beam, and ionizing, by the light field adjustment and control assembly, the air at the display region to form the holographic image; and obtaining brightness information of the holographic image, and controlling the pulse laser regulation assembly and the light field adjustment and control assembly based on the brightness information of the holographic image to enable a brightness of the holographic image to meet a predetermined condition.

In the air ionization display apparatus and the control method for the air ionization display apparatus according to the embodiments of the present disclosure, the pulse laser source may generate the pulse laser beam, and then the beam splitter splits the pulse laser beam into the first sub-beam and the second sub-beam. The pulse laser regulation assembly regulates the wavelength of the second sub-beam to obtain the third sub-beam, and regulates the time difference between the third sub-beam and the first sub-beam to delay the emission of the third sub-beam. The beam combiner combines the first sub-beam and the second sub-beam to obtain the combined beam. The light field adjustment and control assembly adjusts and converges the combined beam, and ionizes the air at the display region to form the holographic image. Therefore, the large range of air ionization at the relatively low output power of the laser source can be realized.

Additional aspects and advantages of the embodiments of present disclosure will be provided at least in part in the following description, or will become apparent at least in part from the following description, or can be learned from practicing the embodiments of the present disclosure.

### BRIEF DESCRIPTION OF THE DRAWINGS

FIG. 1 is a block diagram of a structure of an air ionization display apparatus according to an embodiment of the present disclosure.

FIG. 2 is a block diagram of a structure of an air ionization display apparatus according to another embodiment of the present disclosure.

FIG. 3 is a block diagram of a structure of an air ionization display apparatus according to yet another embodiment of the present disclosure.

FIG. 4 is a schematic diagram of a structure of an optical delay line in an example of the present disclosure.

FIG. 5 is a schematic diagram of a structure of an optical delay line in another example of the present disclosure.

FIG. 6 is a schematic diagram of a structure of a light field adjustment and control assembly in a first example of the present disclosure.

FIG. 7 is a schematic diagram of a structure of a light field adjustment and control assembly in a second example of the present disclosure.

FIG. 8 is a schematic diagram of a structure of a light field adjustment and control assembly in a third example of the present disclosure.

FIG. 9 is a schematic diagram of a structure of a light field adjustment and control assembly in a fourth example of the present disclosure.

FIG. 10 is a schematic diagram of a structure of a light field adjustment and control assembly in a fifth example of the present disclosure.

FIG. 11 is a work flowchart of an air ionization display apparatus according to an embodiment of the present disclosure.

FIG. 12 is a flowchart of a control method for an air ionization display apparatus according to an embodiment of the present disclosure.

### DETAILED DESCRIPTION

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limiting, the present disclosure.

An air ionization display apparatus and a control method for the air ionization display apparatus according to the embodiments of the present disclosure will be described below with reference to the accompanying drawings.

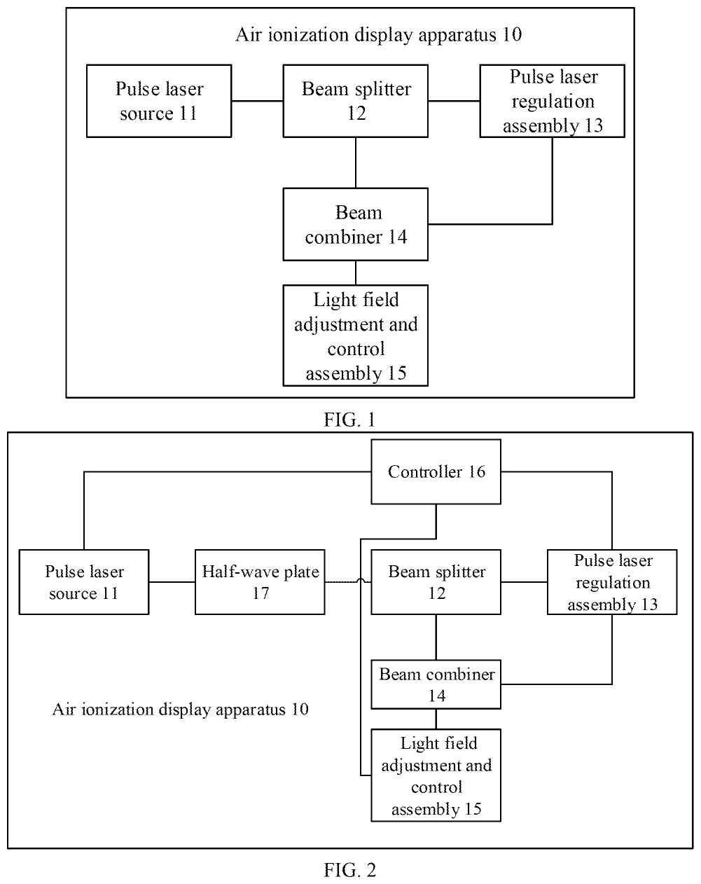

FIG. 1 is a block diagram of a structure of an air ionization display apparatus according to an embodiment of the present disclosure.

As illustrated in FIG. 1, an air ionization display apparatus 10 includes a pulse laser source 11, a beam splitter 12, a pulse laser regulation assembly 13, a beam combiner 14, and a light field adjustment and control assembly 15.

In some embodiments, the pulse laser source 11 is configured to generate a pulse laser beam. The beam splitter 12 is configured to split the pulse laser beam into a first sub-beam and a second sub-beam. The pulse laser regulation assembly 13 is configured to regulate a wavelength of the second sub-beam to obtain a third sub-beam, and regulate a time difference between the third sub-beam and the first sub-beam to delay an emission of the third sub-beam. The beam combiner 14 is configured to combine the first sub-beam and the third sub-beam that is subject to the delayed emission to obtain a combined beam. The light field adjustment and control assembly 15 is configured to adjust and converge the combined beam, and ionize air at a display region to form a holographic image.

The pulse laser beam generated by the pulse laser source 11 may have a pulse width ranging from 50 fs to 100 ns, pulse energy ranging from 20 μj to 10 mJ, a repetition frequency ranging from 500 Hz to 10 MHz, and a wavelength ranging from 1,000 nm to 1,200 nm. The pulse laser source 11 generates the pulse laser beam, and then the pulse laser beam is divided into the first sub-beam and the second sub-beam by the beam splitter 12.

Further, after the pulse laser beam is divided into the first sub-beam and the second sub-beam by the beam splitter 12, the first sub-beam passes through the beam splitter 12 to the beam combiner 14, and the second sub-beam passes through the beam splitter 12 to the pulse laser regulation assembly 13.

The first sub-beam passes through the beam combiner 14 to the light field adjustment and control assembly 15. The light field adjustment and control assembly 15 adjusts and focuses the first sub-beam. The first sub-beam enables molecules or atoms in the air to enter a first excited state at the display region. Since an ionization potential of most molecules or atoms ranges from 5 eV to 20 eV, a wavelength of single photon ionization ranges from 62 nm to 248 nm according to E=hλ/c. That is, generally, an ultraviolet single photon or a single photon in a visible light waveband is unable to ionize the atoms or molecules in the air. Therefore, the first sub-beam enables the atoms or molecules in the air to be excited to the low-energy first excited state at the display region.

The pulse laser regulation assembly 13 regulates the second sub-beam to obtain the third sub-beam. A wavelength of the third sub-beam may range from 800 nm to 2,000 nm. A repetition frequency of the third sub-beam is identical to a repetition frequency of the second sub-beam. Then, the pulse laser regulation assembly 13 delays an output of the third sub-beam to the beam combiner 14. The third sub-beam passes through the beam combiner 14 to the light field adjustment and control assembly 15. The light field adjustment and control assembly 15 adjusts and focuses the third sub-beam. Since the first sub-beam has enabled the air at the display region to enter the first excited state, the third sub-beam may re-excite the atoms or molecules in the air that have been excited to the low-energy first excited state, to ionize the air.

In some embodiments, the number of ionized atoms has the following relations with an optical flow density of the combined beam, a wavelength of the first sub-beam, and the wavelength of the third sub-beam:

$$\frac{{dN}_{0}}{dt} = - {N}_{0} {σ}_{A} ∅ + \frac{{N}_{1}}{{τ}_{1}} + {N}_{1} {σ}_{A} ∅ , \qquad ( 1 )$$

$$\frac{{dN}_{1}}{dt} = {N}_{0} {σ}_{A} ∅ - \frac{{N}_{1}}{{τ}_{1}} - {N}_{1} {σ}_{A} ∅ - {N}_{1} {σ}_{i} ∅ , and \qquad ( 2 )$$

$$\frac{{dN}_{i}}{dt} = {N}_{1} {σ}_{i} ∅ , \qquad ( 3 )$$

where N₀(t) represents the total number of atoms, N₁(t) represents the number of atoms in the first excited state, σ_{A} represents an excited absorption cross section from a ground state to the first excited state, σᵢ represents an ionization cross section from the first excited state to a continuum state, τ_{A} represents a spontaneous emission lifetime of the first excited state, Φ represents the optical flow density of the combined beam, and N₁(t) represents the number of ionized atoms. σ_{A} is related to the wavelength of the first sub-beam. σᵢ is related to the wavelength of the third sub-beam.

By adding equation (1) to equation (2) and differentiating equation (3), equation (4) can be obtained:

$$\frac{{d}^{2} {N}_{1}}{{dt}^{2}} + [ ( 2 {σ}_{A} + {σ}_{i} ) ∅ + \frac{1}{τ} ] \frac{{dN}_{1}}{dt} + {σ}_{A} {σ}_{i} {∅}^{2} {N}_{1} = 0 . \qquad ( 4 )$$

A general solution of the above equation (4) is as follows:

$${N}_{1} = \frac{{N}_{0} {σ}_{i} {σ}_{A} {∅}^{2}}{{λ}_{2} - {λ}_{1}} [ {e}^{- {λ}_{2} t} - {e}^{- {λ}_{1} t} ] , \qquad ( 5 )$$

$$where$$

$${λ}_{2} = b + \sqrt{{b}^{2} - {ξ}^{2}} , and \qquad ( 6 )$$

$${λ}_{1} = b - \sqrt{{b}^{2} - {ξ}^{2}} . \qquad ( 7 )$$

In equation (6) and equation (7), b and ξ² satisfy:

$$2 b = ( 2 {σ}_{A} + {σ}_{i} ) ∅ + \frac{1}{τ} , \qquad ( 8 )$$

$$and$$

$${ξ}^{2} = {σ}_{A} {σ}_{i} {∅}^{2} . \qquad ( 9 )$$

Thus, a solution of the number Ni (t) of ionized atoms is:

$${N}_{i} = \frac{{N}_{0} {σ}_{i} {σ}_{A} {∅}^{2}}{{λ}_{2} - {λ}_{1}} [ \frac{1}{{λ}_{2}} {e}^{- {λ}_{2} t} - \frac{1}{{λ}_{1}} {e}^{- {λ}_{1} t} ] . \qquad ( 10 )$$

Therefore, by regulating a delay of the third sub-beam, the third sub-beam re-excites the atoms or molecules in the air at an appropriate time point after the first sub-beam excites the molecules or atoms in the air to the first excited state. Moreover, through adjusting the wavelength of the third sub-beam, the third sub-beam can perform a resonance excitation on the atoms or molecules in the first excited state. In this way, a threshold of output power required by the laser to ionize the air can be reduced, and a large range of air ionization at a relatively low output power of the laser source can be realized.

It should be noted that, an extinction ratio Tp: Ts of the beam splitter 12 is greater than 1,000: 1, an extinction ratio Tp: Ts of the beam combiner 14 is greater than 1,000: 1, and the light field adjustment and control assembly 15 can control a scanning range of the combined beam with an X direction: 100 mm to 200 mm, a Y direction: 100 mm to 200 mm, and a Z direction: 100 mm to 200 mm The above display region is a three-dimensional display region, and preferably greater than the scanning range of the combined beam.

Further, referring to FIG. 2, the air ionization display apparatus 10 further includes a controller 16 and a half-wave plate 17. The controller 16 is connected to the pulse laser source 11, the pulse laser regulation assembly 13, and the light field adjustment and control assembly 15.

In some embodiments, the controller 16 is configured to control laser outputted by the pulse laser source 11, the pulse laser regulation assembly 13, and the light field adjustment and control assembly 15 based on brightness information of the holographic image, to control the holographic image to be displayed in the display region.

The half-wave plate 17 is configured to regulate polarization of the pulse laser beam outputted by the pulse laser source 11. The pulse laser beam generated by the pulse laser source 11 becomes horizontally polarized light and vertically polarized light after passing through the half-wave plate 17, and then the polarized light may be filtered by the beam splitter 12 and the beam combiner 14. For example, it may be set that the beam splitter 12 has a reflectivity ranging from 0.5% to 1% for the horizontally polarized light, and the beam combiner 14 has a reflectivity ranging from 99% to 99.5% for the vertically polarized light, thereby enabling that the combined beam is substantially the horizontally polarized light. The half-wave plate 17 may have a size ranging from 20 mm to 30 mm.

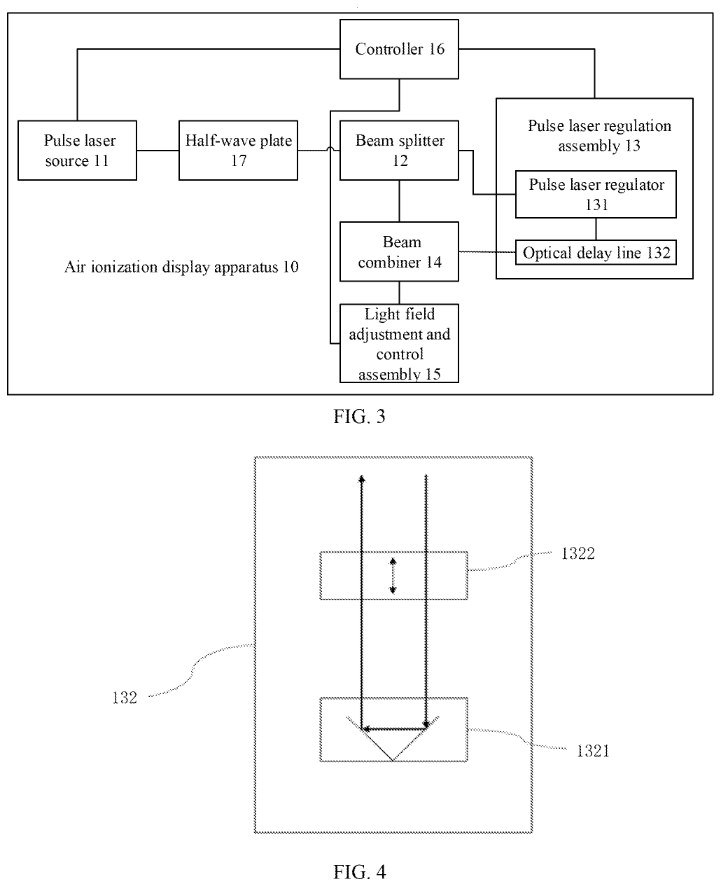

Further, referring to FIG. 3, the pulse laser regulation assembly 13 includes a pulse laser regulator 131 and an optical delay line 132.

In some embodiments, the pulse laser regulator 131 is configured to regulate the wavelength of the second sub-beam to obtain the third sub-beam. For example, the second sub-beam may be used as a pumping source of the pulse laser regulator 131 to excite a laser working material in the pulse laser regulator 131, to enable the pulse laser regulation assembly 13 to generate the third sub-beam; or to enable the second sub-beam to pass through a predetermined medium to change the wavelength of the second sub-beam.

Further, the optical delay line 132 is configured to regulate the time difference between the third sub-beam and the first sub-beam to delay the emission of the third sub-beam.

Referring to FIG. 4, the optical delay line 132 includes a cube-corner prism 1321 and a motorized translation stage 1322. The cube-corner prism 1321 includes two total reflection mirrors that are perpendicular to each other. The cube-corner prism 1321 is configured to reflect the third sub-beam emitted by the pulse laser regulator 131 to the beam combiner 14. The motorized translation stage 1322 is configured to drive the cube-corner prism 1321 to move in an incident direction of the third sub-beam. The motorized translation stage 1322 may have a precision ranging from 1 um to 10 um.

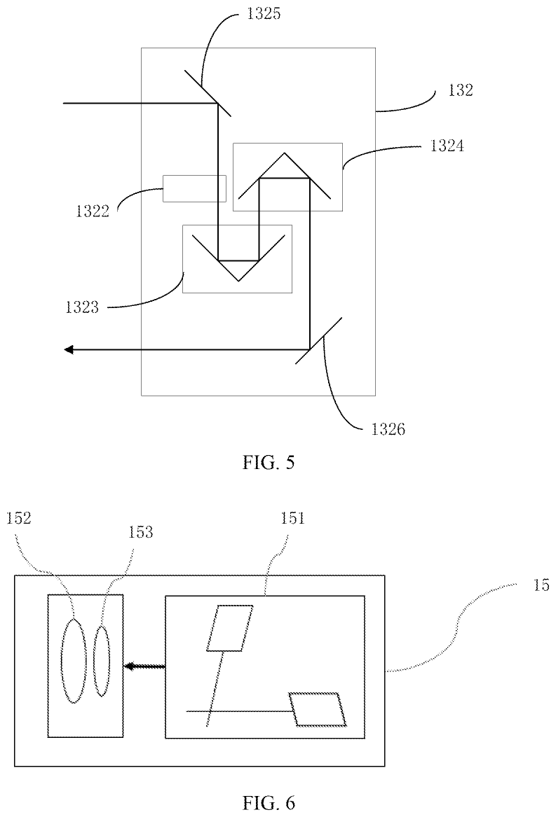

Optionally, referring to FIG. 5, the optical delay line 132 may further include a first cube-corner prism 1323, a second cube-corner prism 1324. a first reflective mirror 1325, and a second reflective mirror 1326, and may further include a motorized translation stage 1322. Each of the first cube-corner prism 1323 and the second cube-corner prism 1324 includes two total reflection mirrors that are perpendicular to each other. One of the two total reflection mirrors of the first cube-corner prism 1323 is disposed directly opposite to one of the two total reflection mirrors of the second cube-corner prism 1324. The first reflective mirror 1325 is configured to reflect the third sub-beam emitted by the pulse laser regulator 131 to the other one of the two total reflection mirrors of the first cube-corner prism 1323. The second reflective mirror 1326 is configured to reflect the third sub-beam emitted by the other one of the two total reflection mirrors of the second cube-corner prism 1324 to the beam combiner 14. The motorized translation stage 1322 is configured to drive at least one of the first cube-corner prism 1323 and the second cube-corner prism 1324 to move in the incident direction of the third sub-beam. A plurality of motorized translation stages 1322 may also be provided, and is in a one-to-one correspondence with the cube-corner prisms. The motorized translation stage 1322 may have a precision ranging from 1 um to 10 um.

It should be noted that the time difference between the third sub-beam and the first sub-beam may range from 100 fs to 10 ns, and may preferably be 1 ps.

Further, referring to FIG. 6, the light field adjustment and control assembly 15 includes an adjustment unit 151, a focusing unit 152, and a zoom unit 153.

In some embodiments, the adjustment unit 151 is configured to perform a direction adjustment on the combined beam. The focusing unit 152 is configured to focus the combined beam subject to the direction adjustment in the display region, and ionize the air at a position of a focal point to form an image. The zoom unit 153 is disposed between a galvanometer unit and the focusing unit 152, and is configured to adjust a divergence angle of a beam emitted by the galvanometer unit and adjust a depth position of the focal point, to display the holographic image.

The adjustment unit 151 includes a galvanometer assembly. The galvanometer assembly includes two groups of reflective mirrors that are perpendicular to each other. The focusing unit 152 includes an f-theta assembly. The zoom unit 153 includes a zoom lens assembly. The two groups of reflective mirrors in the galvanometer unit perform a deflection in a horizontal direction and a deflection in a vertical direction, respectively, to control a position of the focal point on a plane. For example, a position of the focal point in the X direction and the Z direction may be adjusted by using the galvanometer assembly, the position of the focal point in the Y direction may be adjusted by using the zoom unit 153, and thus the focusing unit 152 enables the air at the focal point to be ionized to form an image. Therefore, the holographic image can be displayed by scanning the display region.

Optionally, each of the adjustment unit 151, the focusing unit 152, and the zoom unit 153 may be a replaceable unit, and thus a user can also replace each component in the light field adjustment and control assembly 15 to enable the light field adjustment and control assembly 15 to better meet demands of the user.

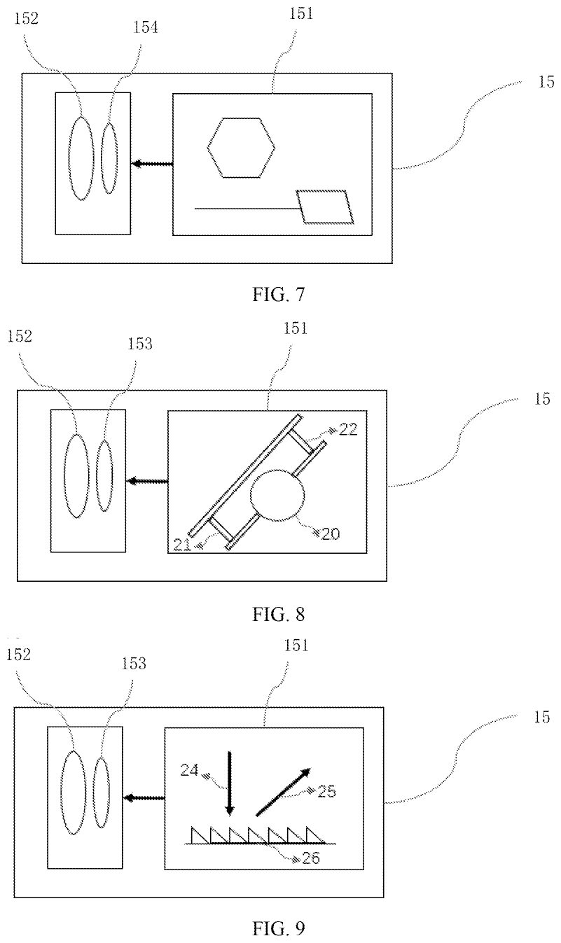

As an example, referring to FIG. 7, the adjustment unit 151 may further include an ultrafast rotary polygonal mirror assembly. The ultrafast rotary polygonal mirror assembly includes a polygonal reflecting body capable of quick rotation. The zoom unit 153 includes an ultrafast deformable mirror assembly. The ultrafast deformable minor assembly includes a piezoelectric material driver and a reflective mirror. As the polygonal reflecting body capable of quick rotation, the ultrafast rotary polygonal mirror assembly has a clear aperture ranging from 15 mm to 20 mm. Since the polygonal reflecting body only needs to rotate in one direction during rotation, the quick rotation can be performed. A rotation speed of the polygonal reflecting body may range from 500 m/s to 600 m/s. The reflective mirror may be composed of a plurality of small reflective minors, or may be a whole piece of thin reflective surface. Therefore, an imaging speed of the light field adjustment and control assembly 15 can be increased.

Alternatively, referring to FIG. 8, the adjustment unit 151 may further include a Micro-Electro-Mechanical System (MEMS) micro mirror. The MEMS micro mirror includes a reflective mirror 20, a fixed electrode 21, and a moving electrode 22. The MEMS micro mirror may deflect, in a specific manner and with a specific time sequence, the combined beam entering the light field adjustment and control assembly 15. Since the reflective mirror has features of small size, electrostatic drive, and no universal joint, the MEMS micro mirror has advantages of high scanning frequency, small size, and low costs, thus the imaging speed of the light field adjustment and control assembly 15 can be increased. Generally, the MEMS micro mirror may have the scanning frequency ranging from 500 Hz to 1,000 Hz.

Alternatively, referring to FIG. 9, the adjustment unit 151 may further include a liquid crystal optical phased array. The liquid crystal optical phased array includes a liquid crystal molecular layer 26. The liquid crystal optical phased array deflects a direction of the combine beam entering the light field adjustment and control assembly 15 by means of regulating an orientation of the liquid crystal molecular layer 26. The liquid crystal optical phased array has features of low drive voltage, high deflection speed, and easy combination with a microelectronic control circuit. In FIG. 9, 24 represents the combined beam, and 25 represents the adjusted combined beam.

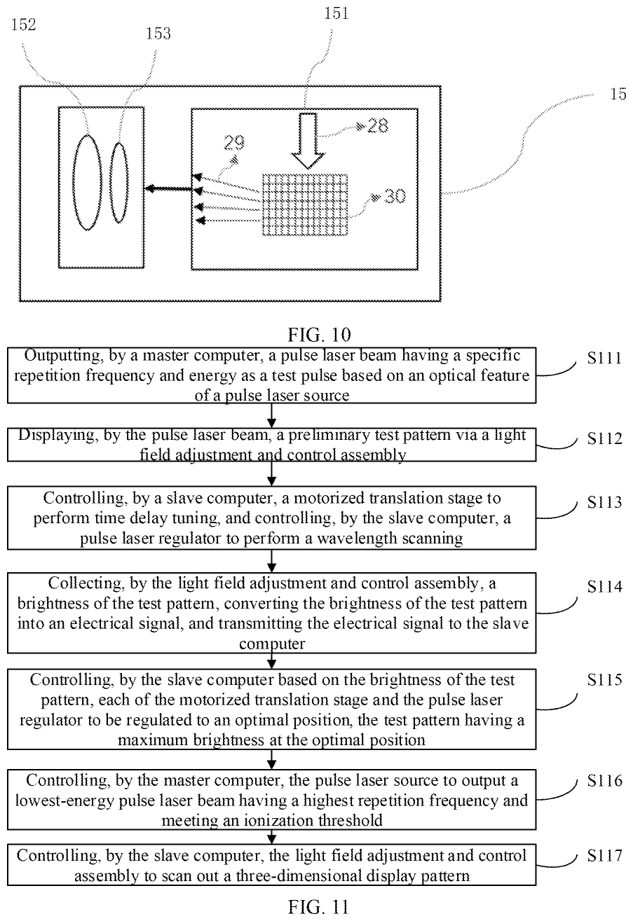

Alternatively, referring to FIG. 10, the adjustment unit 151 may further include a digital micro galvanometer array. The digital micro galvanometer array includes a micro galvanometer array lens 30, e.g., a Digital Micro-mirror Device (DMD) chip. The digital micro galvanometer array can control to focus the combined beam on the display region or not by controlling a switch of the micro galvanometer array lens 30. Generally, the digital micro galvanometer array may have a resolution of 1,280×800, a pixel size ranging from 10 um to 20 um, a wavelength ranging from 850 nm to 2,000 nm, an optical window transmittance greater than 93%, and a frame frequency as high as 5,000 fps. With the digital micro galvanometer array, a frame frequency of three-dimensional display and the imaging speed of the light field adjustment and control assembly 15 can be increased. In FIG. 10, 28 represents the combined beam, and 29 represents the adjusted combined beam.

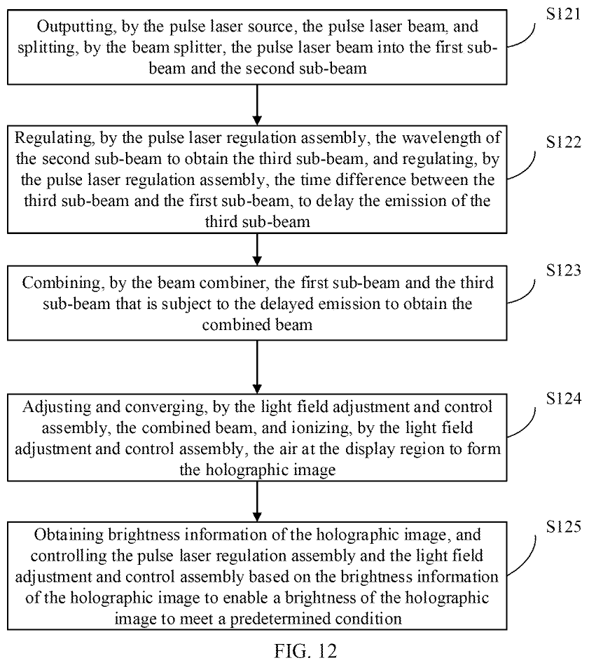

In an embodiment of the present disclosure, as illustrated in FIG. 11, the air ionization display apparatus 10 may form the holographic image at the display region through the following steps.

At S111, a master computer outputs a pulse laser beam having a specific repetition frequency and energy as a test pulse based on an optical characteristic of the pulse laser source.

At S112 the pulse laser beam first displays a preliminary test pattern via the light field adjustment and control assembly.

As an example, the test pattern may be a square.

At S113, the motorized translation stage is controlled by a slave computer to perform time delay tuning, and the pulse laser regulator is controlled by the slave computer to perform a wavelength scanning.

In some embodiments, the motorized translation stage 1322 may be controlled by the slave computer to drive the cube-corner prism to move in the incident direction of the third sub-beam, to change the time difference between the third sub-beam and the first sub-beam, and the pulse laser regulator 131 may be controlled by the slave computer to perform the wavelength scanning to change the wavelength of the third sub-beam.

At S114, a brightness of the test pattern is collected by the light field adjustment and control assembly, is converted into an electrical signal, and is transmitted to the slave computer.

In some embodiments, the light field adjustment and control assembly 15 displays the test pattern at the display region using the test pulse, to collect the brightness of the test pattern.

At S115, the slave computer controls, based on the brightness of the test pattern, each of the motorized translation stage and the pulse laser regulator to be regulated to an optimal position. The test pattern has a maximum brightness at the optimal position.

The optimal position is the time difference between the third sub-beam and the first sub-beam and the wavelength of the third sub-beam that realizes the maximum brightness of the test pattern.

At S116, the master computer controls the pulse laser source to output a lowest-energy pulse laser beam having a highest repetition frequency and meeting an ionization threshold.

Therefore, the light field adjustment and control assembly 15 may use the pulse laser beam to scan at the display region.

At S117, the slave computer controls the light field adjustment and control assembly to scan out a three-dimensional display pattern.

For example, the master computer may be a remote control module, the slave computer may be a field control module. The above controller 16 includes the master computer and the slave computer.

Therefore, the brightness information of the holographic image is obtained, and the pulse laser regulation assembly 13 and the light field adjustment and control assembly 15 are controlled based on the brightness information of the holographic image to enable a brightness of the holographic image to meet a predetermined condition.

To sum up, with the air ionization display apparatus according to the embodiments of the present disclosure, the pulse laser beam is split by the beam splitter into the first sub-beam and the second sub-beam. The air at the display region is excited to the first excited state by using the first sub-beam. The pulse laser regulation assembly regulates the wavelength of the second sub-beam to obtain the third sub-beam, and delays the emission of the third sub-beam. The third sub-beam is used for ionizing the air in the first excited state, which enables the air at the display region to be ionized to form the holographic image. Therefore, a large range of air ionization at a relatively low output power of the laser source can be realized, and thus safety of the air ionization display apparatus is ensured, and costs of the apparatus are reduced. Moreover, through forming the holographic image at the display region, the user can directly watch a three-dimensional image, thereby improving user experience.

FIG. 12 is a flowchart of a control method for an air ionization display apparatus according to an embodiment of the present disclosure.

In this embodiment, the control method for the air ionization display apparatus is applied in the air ionization display apparatus in the embodiments described above.

As illustrated in FIG. 12, the control method for the air ionization display apparatus includes the following steps.

At S121, the pulse laser beam is outputted by the pulse laser source, and the pulse laser beam is split by the beam splitter into the first sub-beam and the second sub-beam.

At S122, the wavelength of the second sub-beam is regulated by the pulse laser regulation assembly to obtain the third sub-beam, and the time difference between the third sub-beam and the first sub-beam is regulated by the pulse laser regulation assembly to delay the emission of the third sub-beam.

At S123, the first sub-beam and the third sub-beam that is subject to the delayed emission are combined by the beam combiner to obtain the combined beam.

At S124, the combined beam is adjusted and converged by the light field adjustment and control assembly, and the air at the display region is ionized by the light field adjustment and control assembly to form the holographic image.

At S125, brightness information of the holographic image is obtained, and the pulse laser regulation assembly and the light field adjustment and control assembly are controlled based on the brightness information of the holographic image to enable a brightness of the holographic image to meet a predetermined condition.

Optionally, subsequent to controlling the pulse laser regulation assembly and the light field adjustment and control assembly based on the brightness information of the holographic image, the pulse laser source may be further controlled to output a lowest-energy pulse laser beam having a highest allowable repetition frequency and meeting an air ionization threshold.

It should be noted that, reference to other specific implementations of the control method for the air ionization display apparatus of the embodiments of the present disclosure can be made to the air ionization display apparatus described above.

To sum up, with the control method for the air ionization display apparatus of the embodiments of the present disclosure, the pulse laser beam is split into the first sub-beam and the second sub-beam. The wavelength of the second sub-beam is regulated to obtain the third sub-beam. The time difference between the third sub-beam and the first sub-beam is regulated to delay the emission of the third sub-beam. The first sub-beam and the third sub-beam that is subject to the delayed emission are combined to obtain the combined beam. The air at the display region is ionized by using the combined beam to form the holographic image. The brightness information of the holographic image is obtained. Controlling is performed based on the brightness information of the holographic image to enable the brightness of the holographic image to meet the predetermined condition. Therefore, the large range of air ionization at the relatively low output power of the laser source can be realized, and thus the safety of the air ionization display apparatus is ensured, and the costs of the apparatus are reduced. Moreover, through forming the holographic image at the display region, the user can directly watch the three-dimensional image, thereby improving the user experience.

It should be noted that the logics and/or steps represented in the flowchart or described otherwise herein can be, for example, considered as a list of ordered executable instructions for implementing logic functions, and can be embodied in any computer-readable medium that is to be used by or used with an instruction execution system, apparatus, or device (such as a computer-based system, a system including a processor, or any other system that can retrieve and execute instructions from an instruction execution system, apparatus, or device). For the present disclosure, a “computer-readable medium” can be any apparatus that can contain, store, communicate, propagate, or transmit a program to be used by or used with an instruction execution system, apparatus, or device. More specific examples of computer-readable mediums include, as a non-exhaustive list: an electrical connector (electronic device) with one or more wirings, a portable computer disk case (magnetic devices), a Random Access Memory (RAM), a Read Only Memory (ROM), an Erasable Programmable Read Only Memory (EPROM or flash memory), a fiber optic device, and a portable Compact Disk Read Only memory (CDROM). In addition, the computer-readable medium may even be paper or other suitable medium on which the program can be printed, as the program can be obtained electronically, e.g., by optically scanning the paper or the other medium, and then editing, interpreting, or otherwise processing the scanning result when necessary, and then stored in a computer memory.

It should be understood that each part of the present disclosure can be implemented in hardware, software, firmware or any combination thereof In the above embodiments, a number of steps or methods can be implemented using software or firmware stored in a memory and executed by a suitable instruction execution system. For example, when implemented in hardware, as in another embodiment, it can be implemented by any one or combination of the following technologies known in the art: a discrete logic circuit having logic gate circuits for implementing logic functions on data signals, an application-specific integrated circuit with suitable combined logic gates, a Programmable Gate Array (PGA), a Field Programmable Gate Array (FPGA), etc.

In the disclosure, the description with reference to the terms “an embodiment”, “some embodiments”, “an example”, “a specific example”, or “some examples”, etc., means that specific features, structures, materials, or characteristics described in conjunction with the embodiment or example are included in at least one embodiment or example of the present disclosure. In this specification, any schematic representation of the above terms does not necessarily refer to the same embodiment or example. Moreover, the specific features, structures, materials or characteristics as described can be combined in any one or more embodiments or examples as appropriate.

In the description of the present disclosure, it is to be understood that, terms such as “center”, “longitudinal”, “lateral”, “length”, “width”, “thickness”, “upper”, “below”, “front”, “back”, “left”, “right”, “vertical”, “horizontal”, “top”, “bottom”, “in”, “out”, “clockwise”, “counterclockwise”, “axial”, “radial”, “circumferential”, etc., is based on the orientation or position relationship shown in the accompanying drawings, and is only for the convenience of describing the present disclosure and simplifying the description, rather than indicating or implying that the associated device or element must have a specific orientation, or be constructed and operated in a specific orientation, and therefore cannot be understood as a limitation on the present disclosure.

In addition, the terms “first” and “second” are only used for descriptive purposes, and cannot be understood as indicating or implying relative importance or implicitly indicating the number of indicated technical features. Therefore, the features associated with “first” and “second” may explicitly or implicitly include at least one of the features. In the description of the present disclosure, “plurality” means at least two, e.g., two, three, etc., unless otherwise specifically defined.

In the present disclosure, unless otherwise clearly specified and limited, terms such as “install”, “connect”, “connect to”, “fix” and the like should be understood in a broad sense. For example, it may be a fixed connection or a detachable connection or connection as one piece; mechanical connection or electrical connection; direct connection or indirect connection through an intermediate; internal communication of two components or the interaction relationship between two components. For those of ordinary skill in the art, the specific meaning of the above-mentioned terms in the present disclosure can be understood according to specific circumstances.

In the present disclosure, unless expressly stipulated and defined otherwise, the first feature “on” or “under” the second feature may mean that the first feature is in direct contact with the second feature, or the first and second features are in indirect contact through an intermediate. Moreover, the first feature “above”, “on” and “over” the second feature may mean that the first feature is directly above or obliquely above the second feature, or simply mean that the level of the first feature is higher than that of the second feature. The first feature “below” and “under” the second feature may mean that the first feature is directly below or obliquely below the second feature, or simply mean that the level of the first feature is smaller than that of the second feature.

Although the embodiments of the present disclosure have been shown and described above, it can be understood that the above-mentioned embodiments are exemplary and should not be construed as limiting the present disclosure. Those of ordinary skill in the art can make changes, modifications, replacements and variations to the above-mentioned embodiments within the scope of the present disclosure.

What is claimed is:

1. An air ionization display apparatus, comprising:
a pulse laser source configured to generate a pulse laser beam;
a beam splitter configured to split the pulse laser beam into a first sub-beam and a second sub-beam;
a pulse laser regulation assembly configured to regulate a wavelength of the second sub-beam to obtain a third sub-beam, and regulate a time difference between the third sub-beam and the first sub-beam to delay an emission of the third sub-beam;
a beam combiner configured to combine the first sub-beam and the third sub-beam that is subject to the delayed emission to obtain a combined beam; and
a light field adjustment and control assembly configured to adjust and converge the combined beam, and ionize air at a display region to form a holographic image.

2. The air ionization display apparatus according to claim 1, further comprising:
a controller connected to the pulse laser source, the pulse laser regulation assembly, and the light field adjustment and control assembly, and configured to control laser outputted by the pulse laser source, the pulse laser regulation assembly, and the light field adjustment and control assembly based on brightness information of the holographic image.

3. The air ionization display apparatus according to claim 1, wherein the pulse laser regulation assembly comprises:
a pulse laser regulator configured to regulate the wavelength of the second sub-beam to obtain the third sub-beam; and
an optical delay line configured to regulate the time difference between the third sub-beam and the first sub-beam to delay the emission of the third sub-beam.

4. The air ionization display apparatus according to claim 3, wherein the optical delay line comprises:
a cube-corner prism comprising two total reflection mirrors perpendicular to each other, the cube-corner prism being configured to reflect the third sub-beam emitted by the pulse laser regulator to the beam combiner; and
a motorized translation stage configured to drive the cube-corner prism to move in an incident direction of the third sub-beam.

5. The air ionization display apparatus according to claim 3, wherein the optical delay line comprises:
a first cube-corner prism and a second cube-corner prism, each of the first cube-corner prism and the second cube-corner prism comprising two total reflection mirrors perpendicular to each other, and one of the two total reflection mirrors of the first cube-corner prism being disposed directly opposite to one of the two total reflection mirrors of the second cube-corner prism;
a motorized translation stage configured to drive at least one of the first cube-corner prism and the second cube-corner prism to move in an incident direction of the third sub-beam; and
a first reflective mirror and a second reflective mirror, the first reflective mirror being configured to reflect the third sub-beam emitted by the pulse laser regulator to the other one of the two total reflection mirrors of the first cube-corner prism, and the second reflective mirror being configured to reflect the third sub-beam emitted by the other one of the two total reflection mirrors of the second cube-corner prism to the beam combiner.

6. The air ionization display apparatus according to claim 1, wherein the light field adjustment and control assembly comprises:
an adjustment unit configured to perform a direction adjustment on the combined beam;
a focusing unit configured to focus the combined beam subject to the direction adjustment in the display region, and ionize the air at a position of a focal point to form an image; and
a zoom unit disposed between a galvanometer unit and the focusing unit, and configured to adjust a divergence angle of a beam emitted by the galvanometer unit and adjust a depth position of the focal point, to display the holographic image.

7. The air ionization display apparatus according to claim 6, wherein:
the adjustment unit comprises a galvanometer assembly, the galvanometer assembly comprises two groups of reflective mirrors that are perpendicular to each other, the focusing unit comprises an f-theta assembly, and the zoom unit comprises a zoom lens assembly; or the adjustment unit comprises an ultrafast rotary polygonal mirror assembly, the ultrafast rotary polygonal mirror assembly comprises a polygonal reflecting body capable of quick rotation, the zoom unit comprises an ultrafast deformable mirror assembly, and the ultrafast deformable mirror assembly comprises a piezoelectric material driver and a reflective mirror surface; or
the adjustment unit comprises a Micro-Electro-Mechanical-System (MEMS) micro mirror, and the MEMS micro mirror comprises a reflective mirror, a fixed electrode, and a moving electrode; or
the adjustment unit comprises a liquid crystal optical phased array, and the liquid crystal optical phased array comprises a liquid crystal molecular layer 26; or
the adjustment unit comprises a digital micro galvanometer array, and the digital micro galvanometer array comprises a micro galvanometer array lens 30.

8. The air ionization display apparatus according to claim 1, further comprising:
a half-wave plate configured to regulate polarization of the pulse laser beam outputted by the pulse laser source.

9. A control method for an air ionization display apparatus, the method being applied in the air ionization display apparatus according to claim 1 and comprising:
outputting, by the pulse laser source, the pulse laser beam, and splitting, by the beam splitter, the pulse laser beam into the first sub-beam and the second sub-beam;
regulating, by the pulse laser regulation assembly, the wavelength of the second sub-beam to obtain the third sub-beam, and regulating, by the pulse laser regulation assembly, the time difference between the third sub-beam and the first sub-beam, to delay the emission of the third sub-beam;
combining, by the beam combiner, the first sub-beam and the third sub-beam that is subject to the delayed emission to obtain the combined beam;
adjusting and converging, by the light field adjustment and control assembly, the combined beam, and ionizing, by the light field adjustment and control assembly, the air at the display region to form the holographic image; and
obtaining brightness information of the holographic image, and controlling the pulse laser regulation assembly and the light field adjustment and control assembly based on the brightness information of the holographic image to enable a brightness of the holographic image to meet a predetermined condition.

10. The control method for the air ionization display apparatus according to claim 9, further comprising, subsequent to said controlling the pulse laser regulation assembly and the light field adjustment and control assembly based on the brightness information of the holographic image:
controlling the pulse laser source to output a lowest-energy pulse laser beam having a highest allowable repetition frequency and meeting an air ionization threshold.
